(19) United States
(12) Patent Application Publication
(10) Pub. No.: US 2023/0078499 A1
(43) Pub. Date: Mar. 16, 2023

(54) METHOD AND DEVICE FOR MONITORING MACHINERY FOR THE PRODUCTION OR TREATMENT OF SYNTHETIC FIBERS

(71) Applicant: Oerlikon Textile GmbH & Co. KG, Remscheid (DE)

(72) Inventors: Jörg Huthmacher, Marl (DE); Marc-André Nehrkorn-Ludwig, Marl (DE)

(21) Appl. No.: 17/801,318

(22) PCT Filed: Mar. 2, 2021
(86) PCT No.: PCT/EP2021/055095

§ 371 Date: Aug. 22, 2022

(30) Foreign Application Priority Data
Mar. 6, 2020 (DE) 10 2020 001 454.2
Jul. 23, 2020 (DE) 10 2020 004 467.0

(51) Int. Cl. G05B 23/02

(52) U.S. Cl. CPC G05B 23/024; G05B 23/0264; G05B 23/0286

(57) ABSTRACT

Techniques monitor machinery for the production or treatment of synthetic fibers. Such techniques involve constant generation and recording of system messages of machine components and control components. Such techniques further involve continuous storage of the system messages as log data in a log memory. Such techniques further involve readout, preprocessing and analysis of the log data with the aid of algorithms based on statistical procedures and machine learning methods in order to identify frequent sequences of system messages and/or an anomaly.

The invention relates to a method for monitoring machinery for the production or treatment of synthetic fibers and to a device for monitoring machinery for the production or treatment of fibers according to the precharacterizing clause of claim 8.

During the production of synthetic fibers, for example during melt spinning, or the treatment of synthetic fibers, for example false-twist texturing, a multiplicity of individual production processes such as extrusion, stretching, swirling, texturing, fixing, winding, etc. influence the quality of the yarns. In this case, each individual production process may in turn be influenced by a multiplicity of parameters. In this regard, a multiplicity of machine components are used, which have actuators and sensors in order to influence the production process and the fiber quality in the desired way. Each of the machine components is assigned a control component, which is connected to a central machine control unit by means of a machine network. For the monitoring and control of complex machinery of this type, it is now known to constantly record state parameters and process parameters and compare them with saved setpoint values. Such a method and such a device for monitoring machinery are disclosed, for example, by DE 10 2018 004 773 A1.

In the known method and the known device, actual values of process parameters, for example a melt pressure or a galette temperature, and actual values of a state parameter, for example a yarn tension, are recorded and used in order to adjust the process parameter to a newly determined setpoint value. In this case, use is made of a machine learning program having algorithms based on statistical procedures and machine learning methods, by which process adjustments for generating uniform fiber qualities are determined.

In practice, however, it has been found that in such machinery, besides process parameters, there are a multiplicity of system messages which contain warning messages, error messages, etc. The system messages, which sometimes occur nanoseconds after one another and some of which contain pure text representations, are not manageable for an operator in their multiplicity. Thus, in particular, only individual types of system messages, for example error messages, are observed and used for monitoring and controlling the machinery.

It is therefore an object of the invention to refine a method of the species for monitoring and controlling machinery for the production or treatment of synthetic fibers, in such a way that as many as possible of the system messages generated in the machinery are usable for control of the machinery.

It is in particular another aim of the invention to allow predictive control of the machinery on the basis of monitoring the machinery for the production or treatment of synthetic yarns.

This object is achieved according to the invention by a method for monitoring machinery for the production or treatment of synthetic yarns as claimed in claim 1.

For the device, the solution according to the invention is achieved by providing a data logger for continuously recording the system messages, a log memory connected to the data logger in order to record the system messages as log data, and a data analysis unit which is connected to the log memory and has at least one data analysis program having an algorithm based on statistical procedures and machine learning methods.

Advantageous refinements of the invention are defined by the features and feature combinations of the respective dependent claims.

The invention has recognized that a succession of system messages could comprise indications of various events. Thus, message sequences may provide indications of “systemic” events, for example the failure of a component, or “operative” events, for example a product change. In this regard, the system messages continuously generated by the machine components, the control components of the actuators and sensors and the process control are constantly recorded and stored as log data in a log memory. The log memory may for this purpose contain a database or a plurality of files. The log data are subsequently read out, preprocessed and analyzed with the aid of an algorithm based on statistical procedures and machine learning methods in respect of sequences of system messages. This includes inter alia identifying frequent sequences or anomalies, carrying out descriptive evaluations or developing prediction models. One particular advantage of the invention is, however, that the amount of information which the system messages contain is reduced to a humanly interpretable level with the sequences.

In this regard, the method variant is provided in which the analytical results, for example a sequence of system messages, are displayed to an operator and evaluated by the operator. Thus, such operators have expert knowledge for assigning sequences of system messages to particular “systemic” or “operative” events inside the machinery. In this case, the system event may already have taken place or may be impending.

By the use of machine learning, there is the possibility of being able to use such expert knowledge constantly. In this regard, the method variant is preferably carried out in which the operator provides their evaluation of the analysis results to the system. This offers the possibility of incorporating the expert knowledge during subsequent data analysis.

In this regard, the method variant in which the sequences of system messages are analyzed by a machine learning system for determining a “systemic” or “operative” event is particularly advantageous. Here, there is the possibility of identifying an event which has already occurred or is likely to occur in the near future from an identified sequence of system messages.

By the method variant in which the analysis event is displayed to an operator, it is particularly advantageous that the operator can directly initiate or prepare for an action in order to remedy or avert the event. For example, wearing parts such as yarn guides may be replaced in good time.

As an alternative, however, there is also the possibility of providing the analysis event to a machine controller and converting it into a control signal for a process modification and/or a process intervention. Thus, automated interventions may also be carried out in the machinery.

In order to ensure that the log data are chronologically present in an intended order, according to one advantageous method variant the system messages are preferably recorded in the log data, and stored in a log memory, with a time index.

Furthermore, it is advantageous for individual machine components or process sections inside the machinery to be analyzable separately. For this purpose, the system messages are recorded in the log data, and stored in the log memory, with a hierarchy index. Thus, in a melt spinning process, the melt generation may be monitored independently of the individual spinning positions. Inside the spinning position, individual machine components, for example galettes or winding machines, may thus be monitored, and their system messages analyzed, separately.

The device according to the invention for monitoring machinery for producing or treating synthetic fibers therefore offers the possibility of allowing manual or automated interventions in the process, in order to preventively counteract perturbing events or more rapidly correct events that have already occurred.

For manual intervention in the process, the refinement of the device according to the invention in which the data analysis unit is connected to a touchscreen in a control station is preferably implemented. In this way, the analysis results or the system events may be displayed directly to an operator. Furthermore, the operator has the possibility of providing their expert knowledge directly to a machine learning system by means of the touchscreen as a function of the analyzed sequences of system messages.

In order to integrate return messages of the operators, the refinement of the device according to the invention is provided in which the data analysis unit has at least one machine learning algorithm by which analysis results and return messages of the operators can be correlated. Such systems have the advantage of learnability so that new connections between sequences and system events can also be discovered without the operator.

For automation, the refinement of the device according to the invention is particularly advantageous in which the data analysis unit is connected to the machine controller in order to transmit machine-readable data, the controller comprising a data conversion module for generating control instructions. Thus, the system events that are found may be converted directly into control instructions.

The invention will be described in more detail below with reference to the appended figures.

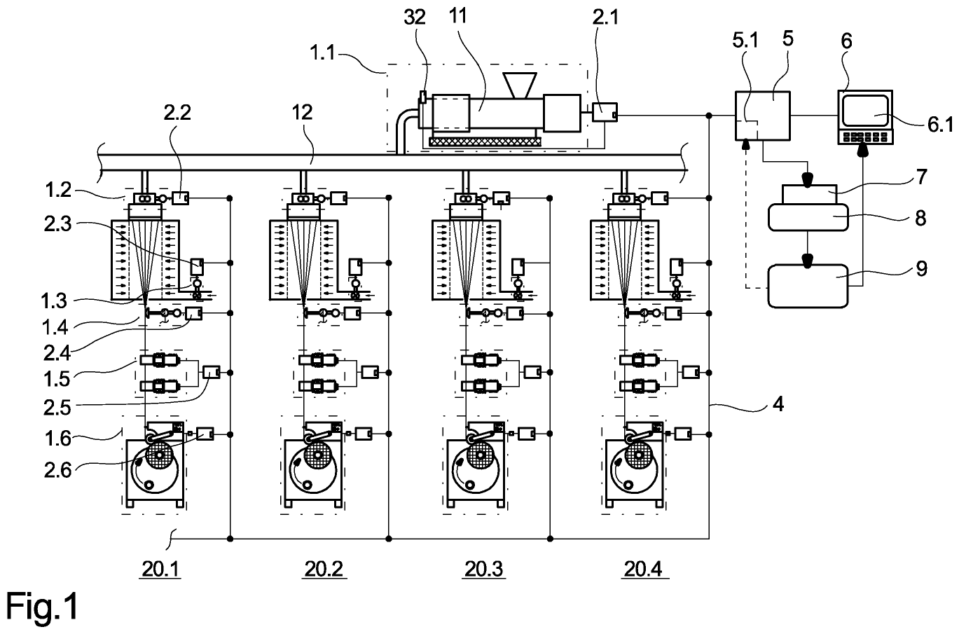

FIG. 1 schematically shows a first exemplary embodiment of the device according to the invention for monitoring machinery for the production of synthetic yarns

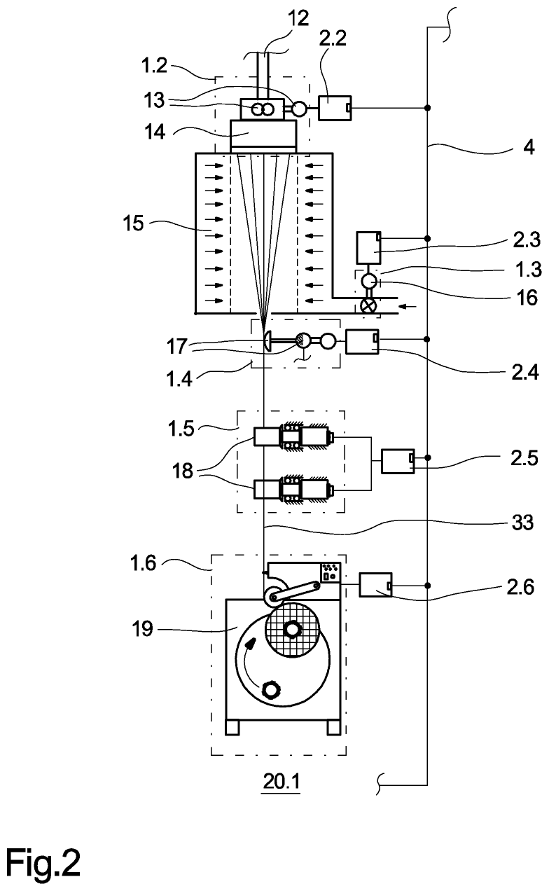

FIG. 2 schematically shows one of the machine fields of the machinery of FIG. 1

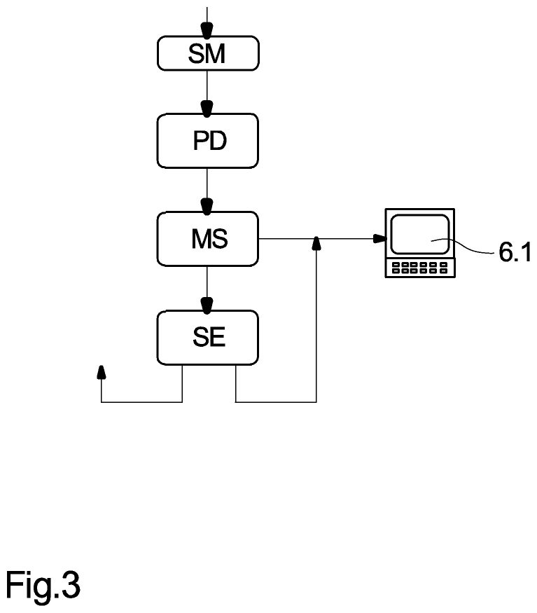

FIG. 3 schematically shows a flowchart of the monitoring of the machinery according to the exemplary embodiment according to FIG. 1

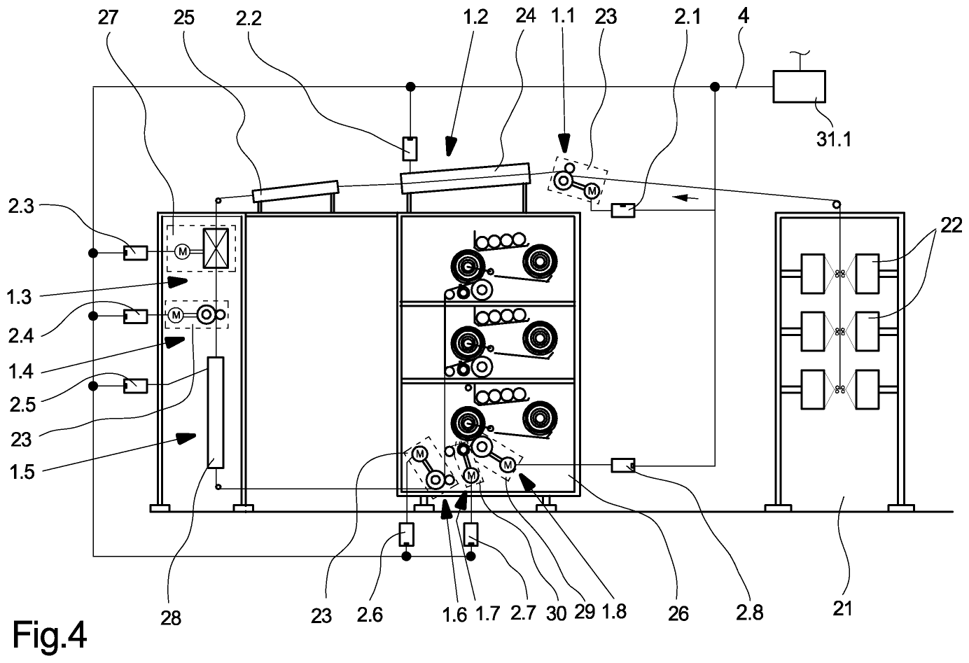

FIG. 4 schematically shows a cross-sectional view of machinery for the treatment of synthetic fibers

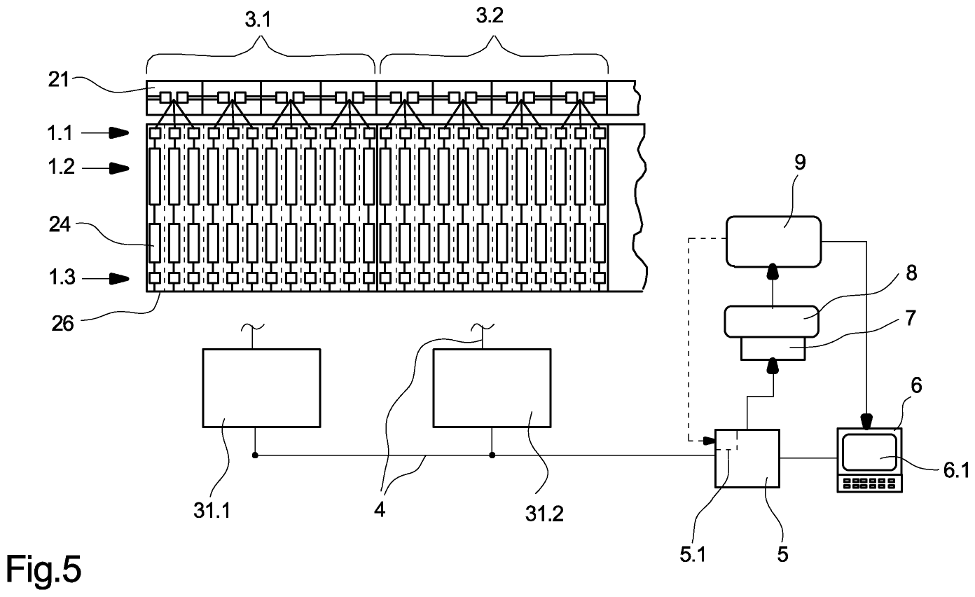

FIG. 5 schematically shows a further exemplary embodiment of the device according to the invention for monitoring the machinery according to FIG. 4

FIGS. 1 and 2 represent machinery for the production of synthetic yarns, having a device according to the invention for monitoring the machinery, in several views. FIG. 1 schematically represents an overall view of the machinery and FIG. 2 schematically represents a partial view of the machinery. If no explicit reference is made to one of the figures, the following description applies for both figures.

The machinery comprises a multiplicity of machine components in order to control the production process for the melt spinning of synthetic fibers, in this case filaments. A first machine component 1.1 is formed by an extruder 11, which is connected by means of a melt line system 12 to a multiplicity of spinning positions 20.1 to 20.4. In FIG. 1, four spinning positions 20.1 to 20.4 are represented by way of example.

The spinning positions 20.1 to 20.4 are constructed identically, one of the spinning positions 20.1 being schematically represented in FIG. 2. Inside the spinning position 20.1, a plurality of machine components 1.2, 1.3, 1.4, 1.5 and 1.6 are provided in order to carry out the spinning of a yarn sheet inside the spinning position. In this regard, a yarn sheet of for example 12, 16 or 32 yarns is produced in each of the spinning positions represented in FIG. 1.

In this exemplary embodiment, the term machine components refers to the machine parts which are crucially involved in the production process by drives, actuators and sensors. Besides the drives and actuators, sensors (not represented here in detail) are also assigned to the machine components which are necessary for controlling the production process. Thus, the spinning position 20.1 comprises as a first machine component 1.2 a spinning pump device 13, which is connected to a melt line system 12 and which interacts for the extrusion of filaments. The spinning pump device 13 is conventionally assigned a pressure sensor and optionally a temperature sensor. A second machine component 1.3 is formed by a fan unit 16, which controls a cooling air supply of a cooling device 15. The cooling device 15 is arranged below the spinning nozzle 14.

A next process step is carried out by the machine component 1.4, which comprises a wetting device 17. The guiding of the yarn sheet for drawing and stretching the filaments is carried out by a machine component 1.5, which comprises a galette unit 18. At the end of the production process, the yarns are wound to form reels. For this purpose, the machine component 1.6 which forms the winding machine 19 is provided.

Inside the spinning position 20.1, the machine components 1.2 to 1.6 are respectively assigned one of a plurality of control components 2.2 to 2.6. Thus, the machine component 1.2 and the control component 2.2 form a unit. Correspondingly, the machine components 1.3 to 1.6 are connected to the assigned control components 2.3 to 2.6.

For communication and data transmission, each of the control components 2.2 to 2.6 is connected by a machine network 4 to a machine control unit 5. The machine network 4, which is preferably formed by an industrial Ethernet, connects the control components 2.2 to 2.6 to the central machine control unit 5.

As may be seen from the representation in FIG. 1, all the control components 2.2 to 2.6 of the spinning positions 20.1 to 20.4 belonging to the machinery are connected by means of the machine network 4 to the machine control unit 5. The machine control unit 5 is connected to a control station 6, from which an operator can control the production process.

Besides the control components 2.2 to 2.6 of the spinning positions 20.1 to 20.4, a control component 2.1 of the extruder 11 is also connected to the machine control unit 5. In this case, the control component 2.1 is for example assigned a pressure sensor 32 on the extruder 11. In this way, all system messages generated in the machinery by the machine components and control components can be provided to the machine control unit 5 via the machine network 4.

As may be seen from the representation in FIG. 1, the machine control unit 5 is assigned a data logger 7 and a log memory 8. In this case, all system messages communicated to the machine control unit 5 are recorded and saved into the log memory inside the log memory 8. The log data of the log memory may in this case be provided with a time index in order to obtain a chronological order in the storage and saving of the system messages. In this case, inter alia, warning messages, error messages, status messages or text messages may be generated as system messages and provided to the machine control unit 5. Besides the time index, the system messages may also be assigned a hierarchy index in order to be able to identify machine components or spinning positions.

The log memory 8 is connected to a data analysis unit 9 in order to directly analyze the log data contained inside the log memory. The data analysis unit 9 contains at least one data analysis program having an analysis algorithm in order to identify preferably repeating sequences of system messages from the log data. Thus, for example, sequence patterns or anomalies or descriptive statistics may be obtained. In this way, compression of the information is firstly achieved in order to allow them to be evaluated by an operator. For instance, it is known from the expert knowledge of the operators that particular sequences of system messages may be correlated with “systemic” or “operative” events, for example yarn breaks, component failures, product changes or component wear. By analyzing the ascertained sequences of system messages, for example, the operator may therefore identify impending events and optionally instigate precautionary measures for process modification or for maintenance of a machine component. The data analysis unit 9 is therefore coupled directly to a touchscreen 6.1 of the control station 6. Besides the visualization of sequences of system messages and other analysis results, the touchscreen 6.1 also allows the direct input of return messages by the operator, so that the expert knowledge can be correlated with the results and used for constant improvement of the analysis results.

FIG. 3 is additionally referred to for further explanation of the method according to the invention and the device according to the invention for monitoring the machinery. FIG. 3 schematically represents a flowchart in order to be able to use the system messages occurring inside the machinery for controlling the machines.

As represented in FIG. 3, all system messages of the machinery are initially logged. The system messages SM are represented in FIG. 3 by the letters SM. The system messages are logged by the data logger 7 and stored in the log memory 8. The collected system messages saved as log data are preferably contained as a database in the log memory. The log memory is denoted by the letters PD and is shown in FIG. 3.

The log data of the log memory PD are read out by the data analysis unit 9 and analyzed constantly with the aid of algorithms based on statistical procedures and machine learning methods. Thus, a search is preferably made initially with the aid of an analysis algorithm for frequent sequences of system messages. In a first analysis of the log data, the conspicuous sequences may thus be determined. Significant compression of the data information is already achieved by this, for example in order to allow them to be evaluated by an operator. The sequences are denoted in FIG. 3 by the letters MS. In order to use the expert knowledge of an operator, these sequences or other analysis results are advantageously provided to the control station 6 in order to be visualized by a touchscreen 6.1. From the sequence of system messages, an experienced operator may therefore already draw conclusions about possible events inside the machinery. For example, a sequence of pressure messages of a melt pressure and yarn breaks may contain an indication that, for example, it is necessary to trim the spinning nozzles in one of the spinning positions. The experience of the operators may also be correlated directly with the analysis results via the touchscreen 6.1 and stored, so as to digitize the expert knowledge of the operators.

In systems in which such expert knowledge of the operators can already be reproduced by machine learning methods, a more in-depth analysis may be carried out in a further step with the aid of return messages of operators. The data analysis program of the data analysis unit 9 may therefore comprise a plurality of algorithms for analysis in greater depth. In this case, for example, particular sequences are assigned possible “systemic” or “operative” events. Particularly in the case of events which with a high probability have already occurred or will occur, these may be transmitted directly to the machine control unit 5.

As represented in FIG. 1, for this purpose the machine control unit 5 comprises a data conversion module 5.1 in which the system events communicated by the data analysis unit 9 are converted into corresponding control instructions. Automated engagement may therefore be carried out in the process, for example in order to be able to perform maintenance on one of the machine components, for example a winding machine in the spinning positions. For instance, it is known that the winding machines receive regular maintenance as a function of their life cycle.

As may be seen from the representation in FIG. 3, however, there is also the possibility of displaying the system event determined by the more in-depth data analysis to an operator for assessment. Particularly in the case of the analysis results for which there are the system events with a lower probability, communication to the control station 6 for visualization of the system event is advantageous.

In order to be able to discover possible sequences of system messages of individual spinning positions or the upstream machine components for melt generation, it is furthermore advantageous to assign the system messages a hierarchy index. With the aid of the hierarchy index and the time index which are added to the system messages, sequences which are to be assigned to the spinning positions or the melt generation may therefore be found by simple data filtering. The system messages of complex machinery may therefore be analyzed both in the overall process and in subprocesses.

In the machinery represented in FIGS. 1 and 2, a process for producing yarns is used as an example. In principle, fibers which are cut to form staple fibers or laid to form nonwovens may be produced in a melt spinning process. Besides the production of the synthetic fibers, however, machinery which carries out a treatment of the fibers, for example a treatment of the yarns or fiber tows, is also known. FIGS. 4 and 5 show an exemplary embodiment of the device according to the invention for monitoring machinery with reference to the example of a texturing machine. For this purpose, FIG. 4 shows a cross-sectional view and FIG. 5 shows a plan view of the texturing machine.

The machinery intended for texturing yarns comprises a multiplicity of processing locations per yarn, hundreds of yarns being treated simultaneously inside the machinery. The processing stations are configured identically inside the machinery and respectively comprise a plurality of machine components for controlling the treatment process.

The machine components 1.1 to 1.8 of one of the processing stations are represented in FIG. 4. In this exemplary embodiment, the machine components 1.1 to 1.8 are formed by a plurality of delivery mechanisms 23, a heater 24, a texturing assembly 27, a set heater 28, a winding device 29 and a traversing device 30.

The machine components 1.1 to 1.8 are arranged successively inside a machine frame 26 to form a yarn path in order to carry out a texturing process. For this purpose, a yarn is provided by a feed bobbin 22 in a rack 21. The yarn is drawn off by the first delivery mechanism 23, heated inside a texturing zone by the heater 24 and subsequently cooled by the cooling device 25. This is followed by texturing and finishing of the yarn, before subsequently being wound to form a reel in the winding device 29.

Since the winding device 29 takes up a relatively large machine width in relation to the upstream machine components 1.1 to 1.6, a plurality of winding devices 29 are arranged in tiers in the machine frame 26. The machine components 1.1 to 1.8 provided in the processing stations are respectively assigned separate control components 2.1 to 2.8 in order to control the respective machine components 1.1 to 1.8 with the assigned actuators and sensors. The control components 2.1 to 2.8 are connected to a field control station 31.1 via a machine network 4.

As may be seen from the representation in FIG. 5, the machine components of a total of 12 processing stations are combined to form a machine field 3.1. The control components 2.1 to 2.8, provided inside the machine field 3.1, of the machine components 1.1 to 1.8 are all integrated in the machine network 4 and connected to the field control station 31.1.

A multiplicity of machine fields are provided in the machinery, only two of the machine fields being shown in this exemplary embodiment. The field control stations 31.1 and 31.2 assigned to the machine fields 3.1 and 3.2 are integrated in the machine network 4 and are coupled to a central machine control unit 5. The function of communication and data transfer is in this case carried out in a similar way to the aforementioned exemplary embodiment of the machinery, so that all system messages of the machine components 1.1 to 1.8 and control components 2.1 to 2.8 of all machine fields 3.1 and 3.2 are ultimately sent to the machine control unit 5 via the machine network 4. The machine control unit 5 is connected to a control station 6 by which the process and the machinery can be monitored and controlled.

In order to be able to use the multiplicity of system messages in order to control the treatment process, besides the machine control unit 5 the device according to the invention comprises at least one data logger 7, a log memory 8 and a data analysis unit 9. The data analysis unit 9 is in this case coupled to the control station 6 in order to visualize results of the data analysis on a touchscreen 6.1 and to receive operator inputs. The system messages in this case likewise contain warning messages, error messages, process perturbations and text information. In this case as well, often possible “systemic” or “operative” events may be tracked by identifying sequences. By adding a hierarchy index, for example, it is possible to establish the machine field in which a possible system event, for example contamination of the cooling device or a wear event of the yarn guide, is imminent. The exemplary embodiment of the device according to the invention for monitoring the machinery is for this purpose substantially identical to the exemplary embodiment mentioned above, so that the flowchart represented in FIG. 3 is also applicable here.

1. A method for monitoring machinery for the production or treatment of synthetic fibers in the following steps:
1.1. constant generation and recording of system messages of machine components and control components;
1.2. continuous storage of the system messages as log data in a log memory, and
1.3. readout, preprocessing and analysis of the log data with the aid of algorithms based on statistical procedures and machine learning methods in order to identify frequent sequences of system messages and/or an anomaly.

2. The method as claimed in claim 1, wherein the sequences of system messages are displayed to an operator for assessment and evaluation by the operator.

3. The method as claimed in claim 2, wherein return messages from a set of operators relating to analysis results are delivered to the machine learning system and stored.

4. The method as claimed in claim 3, wherein the analysis results are correlated with the return messages from the set of operators by the machine learning algorithms to identify “systemic” and “operative” events in the message sequences and to predict events.

5. The method as claimed in claim 4, wherein the system event is displayed to an operator.

6. The method as claimed in claim 4, wherein at least one of the analysis results is delivered to a controller and is converted into a control signal for at least one of a process modification and a process intervention.

7. The method as claimed in claim 6, wherein the system messages are recorded in the log data, and stored in the log memory, with a time index.

8. The method as claimed in claim 7, wherein the system messages are recorded in the log data, and stored in the log memory, with a hierarchy index.

9. A device for monitoring machinery for the production or treatment of synthetic fibers, having a machine controller which is connected to machine components and control components to receive system messages, and further having:
a data logger for continuous recording of the system messages, a log memory connected to the data logger to store the system messages as log data, and a data analysis unit which is connected to the log memory and which comprises at least one data analysis program having algorithms based on statistical procedures and machine learning methods.

10. The device as claimed in claim 9, wherein the data analysis unit is connected to a touchscreen in a control station.

11. The device as claimed in claim 9, wherein the data analysis unit has at least one machine learning algorithm by which analysis results and return messages from a set of operators can be correlated.

12. The device as claimed in claim 11, wherein the data analysis unit is connected to the machine controller in order to transmit machine-readable data, the machine controller comprising a data conversion module for generating control instructions.
